(19) United States
(12) Patent Application Publication
(10) Pub. No.: US 2008/0268113 A1
(43) Pub. Date: Oct. 30, 2008

(54) Activated Carbon Composition and Method for Decolorizing Liquid by Using the Same

(76) Inventors: Toshio Kadowaki, Osaka (JP); Takao Nakahara, Tokushima (JP)

Correspondence Address: KUBOVCIK & KUBOVCIK, SUITE 1105, 1215 SOUTH CLARK STREET, ARLINGTON, VA, 22202, US

(21) Appl. No.: 11/597,529

(22) PCT Filed: May 26, 2004
(86) PCT No.: PCT/JP2004/007182

§ 371 Date: Nov. 27, 2006

(51) Int. Cl. C01B 31/08; C12H 1/048; A23L 2/70

(52) U.S. Cl. 426/257; 502/417

(57) ABSTRACT

An activated carbon composition which is less apt to cause dusting, has satisfactory handleability, and is excellent in decoloration performance, etc. The composition is characterized by comprising activated carbon and cellulose which have been coated with chitosan. Preferably, the composition is one obtained by precipitating chitosan from a chitosan solution in the presence of activated carbon and cellulose to thereby coat the activated carbon and cellulose with the chitosan. The composition is further characterized by containing the cellulose and the chitosan in amounts of 1 to 30 pts.wt. and 0.1 to 15 pts.wt., respectively, per 100 pts.wt. of the activated carbon.

### TECHNICAL FIELD

The present invention relates to an activated carbon composition and a method for decolorizing a liquid by using the same.

### BACKGROUND ART

As methods for decolorizing liquid food products such as liquors and seasonings, there are known methods using decolorizing resins or reverse osmosis membranes. However, such methods are not in widespread use due to high cost of equipment and complicated maintenance. Instead, decolorization methods using powdered activated carbon are generally used.

Such powdered activated carbon to be mainly used for decolorization is prepared by carbonizing sawdust, activating the carbonized sawdust with water vapor or a chemical agent, and pulverizing it.

However, such conventional powdered activated carbon is weak against pressure, and therefore the surface of particles of the powdered activated carbon is abraded by simply rubbing the particles against each other so that powdered coal is generated. Powdered coal can be removed using a sieve, but new powdered coal is again soon generated. Further, such powdered coal is very fine and has a small specific gravity, thus causing a problem that powder dust is generated during handling and therefore working environment becomes bad.

Further, powdered coal contained in the conventional powdered activated carbon does not easily settle out, and is therefore likely to be suspended in supernatant. This causes leakage of powdered coal into filtrate or clogging during diatomite filtration (primary filtration). When filtrate obtained by the primary filtration (hereinafter, simply referred to as “primary filtrate”) is further subjected to microfiltration (secondary filtration) using a membrane filter or the like, powdered coal leaked into the primary filtrate clogs the microfiltration membrane, so that filter blockage occurs. This causes problems that the performance of the secondary filtration is deteriorated and that the cost of filtration is increased due to excessive consumption of expensive filter membranes.

In order to prevent the generation of powder dust, wet powdered activated carbon (wet coal) containing moisture can be used. However, even when such wet powdered activated carbon is used, it is impossible to satisfactorily prevent the generation of powder dust. Further, even in a case where a liquid food product is decolorized using wet powdered activated carbon, there is still a problem that powdered coal is suspended in supernatant and therefore leakage of powdered coal into filtrate or clogging is likely to occur during primary filtration and filter blockage is likely to occur during secondary filtration. In addition, wet coal has a problem that bacteria (miscellaneous bacteria) easily grow therein during storage. Therefore, wet coal is not suitable for use in decolorizing foods such as liquid food products from the viewpoint of food sanitation.

Meanwhile, as activated carbon for deodorizing and decolorizing a surfactant, activated carbon whose surface is coated with chitosan has been proposed (see Japanese Patent Laid-open No. H10-297913).

### DISCLOSURE OF THE INVENTION

However, even in a case where such activated carbon coated with chitosan is used, there are still problems that powder dust is likely to be generated during handling and that leakage of powdered coal into filtrate or clogging occurs during primary filtration and filter blockage or the like occurs during secondary filtration.

It is therefore an object of the present invention to provide an activated carbon composition which is less likely to generate powder dust and which offers excellent handleability and excellent performance in decolorization, and a method for decolorizing a liquid by using such an activated carbon composition.

In order to achieve the above object, the present inventors have conducted extensive research, and as a result have found that an activated carbon composition obtained by coating activated carbon and cellulose with chitosan can solve the above problems, which has led to the completion of the present invention.

Namely, the present invention is directed to an activated carbon composition comprising activated carbon and cellulose which have been coated with chitosan.

By coating activated carbon and cellulose with chitosan, it is possible to obtain an activated carbon composition which is less likely to generate powder dust during handling and which is superior to conventional powdered activated carbon in settling properties and filterability.

It is preferred that the activated carbon composition of the present invention is obtained by precipitating chitosan from a chitosan solution in the presence of activated carbon and cellulose to thereby coat the activated carbon and the cellulose with the chitosan.

It is also preferred that the activated carbon composition of the present invention contains cellulose and chitosan in amounts of 1 to 30 parts by weight and 0.1 to 15 parts by weight, respectively, per 100 parts by weight of activated carbon.

The activated carbon composition of the present invention is particularly suitable for use in decolorizing a liquid food product.

The method for decolorizing a liquid of the present invention comprises the step of bringing the activated carbon composition of the present invention into contact with a liquid to decolorize the liquid.

It is preferred that in the decolorization method of the present invention, the activated carbon composition is used together with at least one selected from the group consisting of silica sol, tannin, and sodium alginate. Among them, sodium alginate is particularly preferably used together with the activated carbon composition. By using the activated carbon composition together with at least one selected from the group consisting of silica sol, tannin, and sodium alginate, it is possible to allow the activated carbon composition to settle out more quickly.

As described above, the activated carbon composition of the present invention comprises activated carbon and cellulose which have been coated with chitosan. Chitosan is a deacetylated product of chitin. The deacetylation degree of chitosan to be used in the present invention is preferably 70% or higher, more preferably 85% or higher.

The amount of chitosan to be used in the present invention is preferably in the range of 0.1 to 15 parts by weight, more preferably in the range of 0.5 to 5 parts by weight, per 100 parts by weight of activated carbon. If the amount of chitosan is less than the above lower limit value, there is a case where the effect of preventing powder dust from being generated from activated carbon is not sufficiently exhibited. On the other hand, if the amount of chitosan exceeds the above upper limit value, the amount of activated carbon is relatively reduced so that there is a case where the ability of the activated carbon composition to decolorize a liquid is deteriorated.

Cellulose to be used in the present invention is not particularly limited. Examples of cellulose to be used in the present invention include cellulose, cellulose hydrolysate, various cellulose adducts, and salts thereof. Particularly, pulp or cottonseed-derived cellulose staple is preferably used. The cellulose staple particularly preferably has a fiber diameter of 10 to 30 μm and a fiber length of 30 to 1,000 μm.

The amount of cellulose to be used in the present invention is preferably in the range of 1 to 30 parts by weight, more preferably in the range of 5 to 15 parts by weight, per 100 parts by weight of activated carbon. If the amount of cellulose is less than the above lower limit value, there is a case where the effect of preventing the generation of powder dust is not sufficiently exhibited. On the other hand, if the amount of cellulose exceeds the above upper limit value, the amount of activated carbon is relatively reduced, so that there is a case where the ability of the activated carbon composition to decolorize a liquid is deteriorated.

In the present invention, the amount of cellulose to be used per 100 parts by weight of chitosan is preferably in the range of 10 to 5,000 parts by weight, more preferably in the range of 50 to 2,000 parts by weight.

The type and particle size of activated carbon to be used in the present invention are not particularly limited, but powdered activated carbon is preferably used. Particularly, sawdust-derived powdered activated carbon which is likely to generate powdered coal, activated carbon containing a large amount of powdered coal, or particulate activated carbon comprising minus sieve particles of activated carbon is preferably used because the effect of the present invention becomes conspicuous when such activated carbon is used.

The activated carbon composition of the present invention can be produced by, for example, dissolving chitosan in an acid solution adjusted to pH 3.0 to 4.5 by adding an organic acid such as lactic acid, acetic acid, or citric acid to prepare a chitosan solution, adding cellulose and activated carbon to the chitosan solution, precipitating chitosan in the presence of the mixture of the activated carbon and the cellulose by adding an aqueous alkaline solution such as an aqueous sodium hydroxide solution or an aqueous potassium hydroxide solution to the chitosan solution to adjust pH to 8.0 to 9.5 to thereby coat the activated carbon and the cellulose with the chitosan, filtering the chitosan solution to obtain the activated carbon and cellulose coated with chitosan, washing them with water, and drying them.

The concentration of chitosan in the chitosan solution is preferably in the range of 0.02 to 4 wt %. The amount of the chitosan solution is preferably in the range of 300 to 1,000 parts by weight per 100 parts by weight of activated carbon to be added to the chitosan solution.

As described above, the activated carbon composition of the present invention is obtained by coating activated carbon and cellulose with chitosan. More specifically, the surface of the activated carbon and cellulose shall be partially coated with chitosan.

Further, as described above, the activated carbon composition of the present invention is suitable for use in decolorizing a liquid such as a liquid food product. Examples of a liquid to which the decolorization method of the present invention can be applied include sake, mirin (rice cooking wine), shochu, liqueurs, miscellaneous liquors, wines, beer, whiskeys, Shaoxing rice wine, vinegars, soy sauce, fish sauce, hydrolyzed vegetable protein, fruit juices, honey, molasses, tea, various animal and plant extracts, and fermentation liquids. Further, the decolorization method of the present invention can be applied to various processes including preparation of raw materials, purification, and disposal of liquids such as the liquid food products mentioned above.

The decolorization method of the present invention comprises the step of bringing the activated carbon composition of the present invention into contact with a liquid to decolorize the liquid. Specific examples of a method for treating a liquid include: (1) a method in which the activated carbon composition of the present invention is directly added to and mixed with a liquid and the resulting mixture is filtered; (2) a method in which the activated carbon composition of the present invention is directly added to and mixed with a liquid and supernatant is filtered after the activated carbon composition settles out; (3) a method in which a liquid is filtered through the activated carbon composition of the present invention accumulated on filter paper or filter fabric; and (4) a method in which a liquid is filtered through the activated carbon composition of the present invention packed in a column.

Examples of a filtration method include natural filtration, pressure filtration, and centrifugal filtration. In a case where the activated carbon composition of the present invention is used, supernatant can be easily filtered because the activated carbon composition more quickly settles out as compared to conventional powdered activated carbon. Further, in a case where the activated carbon composition of the present invention is used together with silica sol, tannin, or sodium alginate, the activated carbon composition can much more quickly settles out.

Silica sol to be used in the present invention is not particularly limited, and can be selected from a wide range of choices including well known silica sols. Among them, silica sols whose SiO₂ content is in the range of about 16 to 50 wt % are preferably used. Among such silica sols, silica sols whose Fe content in solid matter is about 10 ppm or less are particularly preferably used. Specific examples of such silica sols include “Coporoc 300” and “Coporoc SA” manufactured by Otsuka Foods Co., ltd.

Examples of tannin to be used in the present invention include tannin-containing substances such as persimmon tannin and tannic acid.

An example of sodium alginate to be used in the present invention includes “Copolap A” manufactured by Otsuka Foods Co., Ltd.

The amount of silica sol, tannin, or sodium alginate to be used in the present invention is preferably in the range of about 50 to 3,000 ppm, 50 to 3,000 ppm, or 10 to 100 ppm, respectively, per 5 to 10,000 ppm of the activated carbon composition contained in a liquid.

The use of the activated carbon composition of the present invention makes it possible to prevent leakage of powdered coal into filtrate or clogging during diatomite filtration (primary filtration) and to improve the turbidity of filtrate. In a case where microfiltration (secondary filtration) is further carried out, the filtrate can be smoothly filtered without filter blockage.

In the decolorization method of the present invention, an additive can be used together with the activated carbon composition of the present invention and the silica sol or the like described above to the extent that the effect of the present invention is not impaired. Examples of such an additive include: proteins such as gelatin, peptide, polypeptide, collagen, fish gelatin, albumen, wheat protein, and pea protein; polysaccharides such as sodium alginate, carrageenan, agar, and chitosan; gelling agents such as sodium polyacrylate; PVPP (polyvinyl polypyrrolidone); silicon dioxide such as silica gel; filter aids such as diatomite, cellulose, calcium silicate, and calcium titanate; and adsorbents such as bentonite, acid clay, talc, and alum. These additives can be used singly or in combination of two or more of them.

The activated carbon composition of the present invention is less likely to generate powder dust before packing, after opening a package, during operation of filtration or the like, and is therefore excellent in handleability. Further, the activated carbon composition of the present invention is superior in filterability and settling properties to conventional powdered activated carbon.

### BEST MODE FOR CARRYING OUT THE INVENTION

Hereinbelow, the present invention will be described in detail with reference to the following example, but the present invention is not limited thereto.

### <Preparation of Activated Carbon Composition>

150 mL of water was added to 0.05 g of chitosan (average molecular weight: 75,000, deacetylation degree: 89%), and then lactic acid was added thereto little by little under stirring to completely dissolve the chitosan to prepare a chitosan solution. To the chitosan solution, 4.45 g of powdered activate carbon (manufactured by Futamura Chemical Co., Ltd. under the trade name of “FCS”) and 0.5 g of pulp-derived cellulose (average fiber diameter: 20 μm, average fiber length: 200 μm) were added. When the pH of the chitosan solution was confirmed to be 3.9 or less, the chitosan solution was stirred for 5 minutes, and then a 1 vol % aqueous sodium hydroxide solution was added to the chitosan solution little by little. After the pH of the chitosan solution was confirmed to be 9.0 or higher, the chitosan solution was left standing for 30 minutes to precipitate chitosan. Then, the chitosan solution was filtered to obtain an activated carbon composition, and then the activated carbon composition was washed with water and dried. The amount of the thus obtained activated carbon composition of the present invention (activated carbon: 89 wt %, cellulose: 10 wt %, chitosan: 1 wt %) was 5 g.

### <Comparative Activated Carbon 1>

The same powdered activated carbon as used for preparing the activated carbon composition of the present invention was used as comparative activated carbon 1.

### <Preparation of Comparative Activated Carbon 2>

4.5 g of comparative activated carbon 2 (activated carbon: 99 wt %, chitosan: 1 wt %) was prepared in the same manner as in the case of preparing the activated carbon composition except that only the powdered activated carbon was coated with chitosan without using the pulp-derived cellulose.

### EXAMPLE 1

Measurement of Scattering Range of Powder Dust

2 g of each of the activated carbon composition, comparative activated carbon 1, and comparative activated carbon 2 was sampled, and was then dropped from a height of 20 cm to measure the scattering range of the activated carbon (i.e., the maximum diameter of the range). The measurement results are shown in Table 1.

TABLE 1

| | Scattering Range |
|---|---|
| Activated Carbon Composition | 15 cm |
| Comparative Activated Carbon 1 | 35 cm |
| Comparative Activated Carbon 2 | 25 cm |

As can be seen from the results shown in Table 1, in the case of the activated carbon composition according to the present invention, the scattering range was smaller as compared to the case of the comparative activated carbon 1 or 2. This indicates that the activated carbon composition is less likely to generate airborne powder dust.

### EXAMPLE 2

Measurement of Turbidity of Filtrate

0.2 g of each of the activated carbon composition according to the present invention, comparative activated carbon 1, and comparative activated carbon 2 was sampled, and was then added to and mixed with 100 mL of sake. Then, the sake was filtered through filter paper No. 5A, and the turbidity of the resulting filtrate was measured using a turbidimeter (manufactured by Nippon Denshoku Industries Co., Ltd. under the trade name of “NDH-20D”). Thereafter, 50 mL of the filtrate was sampled, and was then filtered through a 0.45 μm filter to visually check the presence or absence of leakage of powdered coal into the filtrate. Table 2 shows the result of measuring the turbidity of filtrate and the result of checking the presence or absence of leakage of powdered coal into filtrate.

TABLE 2

| | | Presence or Absence of |
|---|---|---|
| | Turbidity | Powdered Coal Leaked |
| | of Filtrate | into Filtrate |
| Activated Carbon Composition | 0.1% | Absent |
| Comparative Activated Carbon 1 | 0.7% | Present |
| Comparative Activated Carbon 2 | 0.3% | Present |

As can be seen from the results shown in Table 2, the use of the activated carbon composition according to the present invention makes it possible to significantly reduce the turbidity of filtrate and to suppress the leakage of powdered coal into filtrate.

### EXAMPLE 3

Settling Properties

0.2 g of each of the activated carbon composition, comparative activated carbon 1, and comparative activated carbon 2 was sampled, and was then added to and mixed with 100 mL of sake. After a lapse of 120 minutes, the turbidity of supernatant was measured using the same turbidimeter as used in the Example 2. The measurement results are shown in Table 3.

TABLE 3

| | Turbidity of Supernatant |
|---|---|
| Activated Carbon Composition | 8.5% |
| Comparative Activated Carbon 1 | 25.7% |
| Comparative Activated Carbon 2 | 15.2% |

As can be seen from the results shown in Table 3, in the case of the activated carbon composition according to the present invention, the turbidity of supernatant was significantly lower as compared to the case of the comparative activated carbon 1 or 2. This indicates that the activated carbon composition quickly settles out and therefore powdered coal is less likely to be suspended in supernatant.

### EXAMPLE 4

Test for Determining the Ability of Silica Sol, Persimmon Tannin or Sodium Alginate to Promote Settling of Activated Carbon

0.2 g of each of the activated carbon composition and comparative activated carbon 1 was sampled, and was then added to and mixed with 100 mL of sake. Then, silica sol (manufactured by Otsuka Foods Co., Ltd. under the trade name of “Coporoc 300”), persimmon tannin (manufactured by Iwamoto Kametaro Shoten under the trade name of “H-1”) or sodium alginate (manufactured by Kimica corporation under the trade name of “Kimica Algin I-3”) was added to and mixed with the sake so that the concentration thereof was 1,000 mL/kL, 1,000 mL/kL, or 100 g/kL, respectively. After a lapse of 1 hour, 5 hours, and 24 hours, the turbidity of supernatant was measured using the same turbidimeter as used in the Example 2. The measurement results are shown in Table 4.

TABLE 4

| Type of | | | | |
|---|---|---|---|---|
| Additive | | After 1 hr. | After 5 hrs. | After 24 hrs. |
| No Additives | Activated Carbon Composition | 14.8% | 7.2% | 3.4% |
| | Comparative Activated Carbon 1 | 27.2% | 17.5% | 10.0% |
| Coporoc 300 | Activated Carbon Composition | 7.6% | 4.4% | 2.1% |
| (1,000 mL/kL) | Comparative Activated Carbon 1 | 38.2% | 25.3% | 14.1% |
| Persimmon | Activated Carbon Composition | 9.2% | 5.2% | 2.3% |
| Tannin | Comparative Activated Carbon 1 | 38.3% | 24.6% | 14.0% |
| (1,000 mL/kL) | | | | |
| Sodium | Activated Carbon Composition | 6.5% | 4.1% | 1.4% |
| Alginate | Comparative Activated Carbon 1 | 26.2% | 18.9% | 13.4% |
| (100 g/kL) | | | | |

As can be seen from the results shown in Table 4, in a case where the activated carbon composition according to the present invention was used together with silica sol, persimmon tannin, or sodium alginate, the turbidity of supernatant was lower as compared to a case where such an additive was not used. This indicates that such an additive can promote the settling of the activated carbon composition.

1. An activated carbon composition comprising activated carbon and cellulose which have been coated with chitosan.

2. The activated carbon composition according to claim 1, wherein the activated carbon and cellulose coated with chitosan are obtained by precipitating chitosan from a chitosan solution in the presence of activated carbon and cellulose.

3. The activated carbon composition according to claim 1, wherein the cellulose and the chitosan are contained in amounts of 1 to 30 parts by weight and 0.1 to 15 parts by weight, respectively, per 100 parts by weight of the activated carbon.

4. The activated carbon composition according to claim 1, which is used for decolorizing a liquid food product.

5. A method for decolorizing a liquid, comprising the step of bringing the activated carbon composition according to claim 1 into contact with a liquid to decolorize the liquid.

6. The method for decolorizing a liquid according to claim 5, wherein the activated carbon composition is used together with at least one selected from a group consisting of silica sol, tannin, and sodium alginate.
